(19) United States
(12) Patent Application Publication
(10) Pub. No.: US 2026/0356225 A1
(43) Pub. Date: Nov. 12, 2026

(54) VEHICLE DOCKING STATION SYSTEM

(71) Applicant: PACCAR Inc, Bellevue, WA (US)

(72) Inventors: Brian Hannon, Renton, WA (US); Josef Tarp, Sammamish, WA (US); Nils Koliha, San Leandro, CA (US)

(73) Assignee: PACCAR Inc, Bellevue, WA (US)

(21) Appl. No.: 19/202,926

(22) Filed: May 8, 2025

(51) Int. Cl. B60L 53/302; B60L 53/12; B60L 53/36; B60L 53/38

(52) U.S. Cl. CPC B60L 53/302; B60L 53/12; B60L 53/36; B60L 53/38

(57) ABSTRACT

A docking station system and its components are disclosed. In some examples, the docking station system may include an air shield and/or a docking station. The air shield is configured to restrict airflow from under a vehicle. In some examples, the air shield is coupled to the docking station. For example, the air shield may extend from the docking station towards a front portion of the vehicle. In some other examples, the air shield is coupled to the vehicle. For example, the air shield may extend from the front portion of the vehicle towards the ground. Additionally, the docking station system may align a first wireless charging device of the vehicle with a second wireless charging device below the vehicle. In some examples, when the docking station receives the set of tires, or when another condition is satisfied, the air shield may be deployed to restrict airflow under the vehicle.

### BACKGROUND

Large electric vehicles such as electric trucks often have large batteries or battery packs to allow them to travel long distances and haul cargo. Wireless charging technology allows for such batteries to be charged without operator involvement. However, wirelessly charging large electric vehicles while the vehicle is at rest results in a significant generation of heat that remains local to the vehicle. Such vehicles may include a cooling system including a cooling system that uses ambient air to cool batteries, electrical components and/or a wireless charging system for the vehicle in such cases. However, air heated by the cooling system while the vehicle is charging may seep into the cool or ambient air intake of the cooling system, which may result in the cooling system or wireless charging system not being efficient or being insufficiently cooled, potentially damaging the wireless charging system and/or other components of the vehicle.

It is with respect to this general technical environment that aspects of the present technology disclosed herein have been contemplated. Furthermore, although a general environment is discussed, it should be understood that the examples described herein should not be limited to the general environment identified herein.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

In an aspect, the present application relates to a docking station system for a vehicle, comprising: a docking station configured to receive a set of tires of the vehicle to align the vehicle; and an air shield coupled to a front alignment portion of the docking station and configured to extend upwards from the docking station and, when a vehicle is docked at the docking station, to restrict air flow from beneath the vehicle to a cooling system.

In some examples, the docking station comprises base pads that receive the set of tires, side alignment bars that align the set of tires, a front alignment portion disposed between portions of the base pads and the side alignment bar, and back bars that extend from the base pads.

In some examples, the air shield is fixedly coupled to the docking station.

In some examples, a distal end of the air shield is configured to be deformable.

In some examples, the air shield is configured to extend substantially vertically when in a deployed position and extend substantially horizontally when in a stowed position.

In some examples, the air shield is configured to move from the stowed position to the deployed position when base pads of the docking station receive the set of tires of the vehicle.

In some examples, at least a portion of the air shield is configured to flexibly mold to a front portion of the vehicle upon contact with the front portion of the vehicle.

In some examples, the air shield comprises a plurality of flexible fingers or bristles.

In some examples, the air shield is configured to move from a stowed position to a deployed position, and wherein the air shield moving from the stowed position to the deployed position occurs in response to a signal.

In some examples, the front alignment portion aligns the vehicle such that a first wireless electric charging device of the vehicle is disposed over a second wireless electric charging device below the vehicle.

In some examples, the air shield is configured to move from a stowed position to a deployed position based at least in part on a force exerted by the set of tires of the vehicle on at least one pressure sensor disposed on the docking station.

In another aspect, the present application relates to a docking station system, comprising: a docking station configured to receive at least one tire of a vehicle to align the vehicle, wherein the docking station is configured to provide a signal to cause an air shield to move from a stowed position to a deployed position to restrict air flow from beneath the vehicle to a cooling system.

In some examples, the docking station system further comprises the air shield.

In some examples, the air shield is coupled to the docking station.

In some examples, the docking station further comprises a pressure sensor, and wherein the signal is provided based at least in part on a signal from the pressure sensor indicating that the vehicle is docked at the docking station.

In another aspect, the present application relates to a system, comprising: an air shield configured to restrict flow of air from under a vehicle; at least one processor; and memory, operatively connected to the at least one processor and storing executable instructions that, when executed, cause the at least one processor to perform operations, the operations comprising: detecting that the vehicle is in position for wireless charging of the vehicle; and providing at least one signal to move the air shield from a stowed position to a deployed position based at least in part on detecting that the vehicle is in position for wireless charging of the vehicle.

In some examples, detecting that the vehicle is in position for wireless charging comprises determining that the docking station receives a set of tires of the vehicle to align the vehicle.

In some examples, the air shield is coupled to the docking station and wherein the processor or memory comprise a portion of the vehicle or of the docking station.

In some examples, detecting that the vehicle is in position for wireless charging comprises determining that the vehicle is in a wireless charging mode.

In some examples, the air shield is coupled to the vehicle and wherein the processor or memory comprise a portion of the vehicle or of the docking station.

It is to be understood that both the foregoing general description and the following Detailed Description are explanatory and are intended to provide further aspects and examples of the disclosure as claimed.

### BRIEF DESCRIPTION OF THE DRAWINGS

The following drawing figures, which form a part of this application, are illustrative of aspects of systems and methods described below and are not meant to limit the scope of the disclosure in any manner, which scope shall be based on the claims.

FIG. 1 illustrates a perspective view of a vehicle system.

FIG. 2 illustrates a top cross-sectional view of the vehicle system of FIG. 1.

FIG. 3 illustrates another perspective view of the vehicle system of FIG. 1.

FIG. 4 illustrates a perspective view of a docking station system of FIG. 1.

FIG. 5 illustrates another perspective view of the docking station system of FIG. 1.

FIG. 6 illustrates a top view of the docking station system of FIG. 1.

FIG. 7 illustrates a side view of the docking station system of FIG. 1.

FIG. 8 illustrates a front view of the docking station system of FIG. 1.

FIG. 9 illustrates a conceptual depiction of certain features of the vehicle system of FIG. 1.

FIG. 10 illustrates another conceptual depiction of certain features of the vehicle system of FIG. 1.

FIG. 11 is a block diagram depicting an example computing environment in which systems and methods of the present application may be implemented.

While examples of the disclosure are amenable to various modifications and alternative forms, specific aspects have been shown by way of example in the drawings and are described in detail below. The intention is not to limit the scope of the disclosure to the particular aspects described. On the contrary, the disclosure is intended to cover all modifications, equivalents, and alternatives falling within the scope of the disclosure and the appended claims.

### DETAILED DESCRIPTION

Large electric vehicles such as electric trucks often have large batteries or battery packs to allow them to travel long distances and haul cargo. Wireless charging technology allows for such batteries to be charged without operator involvement. However, wirelessly charging large electric vehicles while the vehicle is at rest results in a significant generation of heat that remains local to the vehicle. Such vehicles may include a cooling system including a cooling system that uses ambient air to cool batteries, electrical components and/or a wireless charging system for the vehicle in such cases. However, air heated by the cooling system while the vehicle is charging may seep into the cool or ambient air intake of the cooling system, which may result in the cooling system or wireless charging system not being efficient or being insufficiently cooled, potentially damaging the wireless charging system and/or other components of the vehicle.

Systems and methods described herein provide for a docking station system to, in part, restrict hot air generated by the cooling system and/or other vehicle components from seeping back into the intake of the cooling system. The docking station system may include an air shield and/or a docking station. The air shield is configured to restrict (e.g., block) airflow from under the vehicle towards the intake portion of the cooling system. In some examples, the air shield is coupled to the docking station. For example, the air shield may extend from the docking station such that, when the vehicle is positioned on the docking station for charging, the air shield extends towards a front portion of the vehicle (e.g., upwards). In some other examples, the air shield is coupled to the vehicle. For example, the air shield may extend from the front portion of the vehicle towards the ground or towards the top of the front portion of the docking station.

Additionally, the docking station system may align, a first wireless charging device of the vehicle with a second wireless charging device below the vehicle to wirelessly charge the vehicle. For example, the docking station of the docking station system may be configured to receive a set of tires of the vehicle to align the vehicle to wirelessly charge the vehicle such that when the docking station system receives the set of tires of the vehicle, a first wireless charging device of the vehicle may align with a second wireless charging device below the vehicle. In some examples, in response to the docking station receiving the set of tires, or when another condition is satisfied, the air shield may be deployed to restrict the flow of heated air from under the vehicle from reaching the intake of the cooling system, which may in some examples be located on a front portion of the vehicle.

As will be understood by those of skill in the art, any reference to “top,” “bottom,” “front,” “rear,” “back,” “side,” etc. are used to describe various components of a vehicle system when in the orientations shown, for example, in the figures, or alternatively with respect to a normal and standard orientation of a vehicle as is understood by one of ordinary skill in the art (e.g., forward refers to a direction of normal and/or straight movement of a vehicle when in use, top refers to a direction away from the ground when the vehicle is oriented in a standard way with all tires contacting the ground surface, etc.); however, the components described herein can be utilized in a variety of orientations.

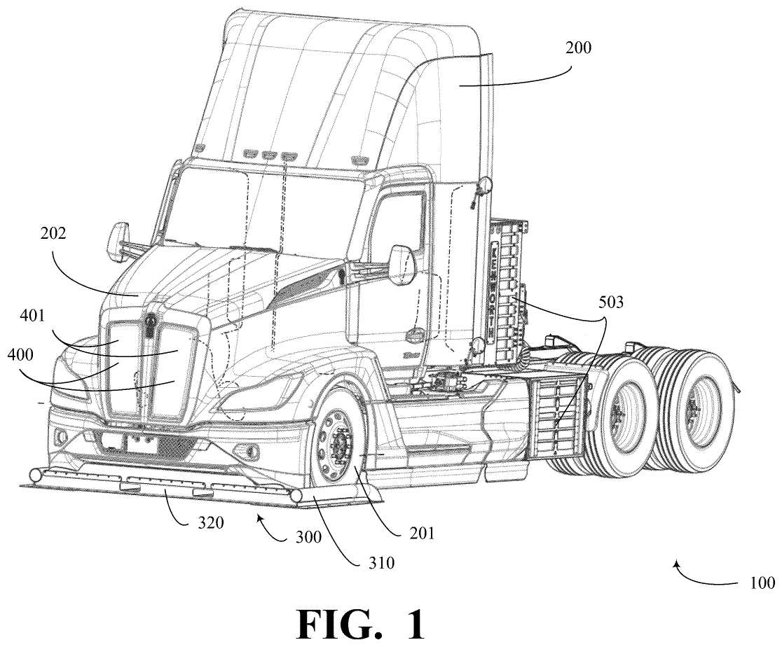

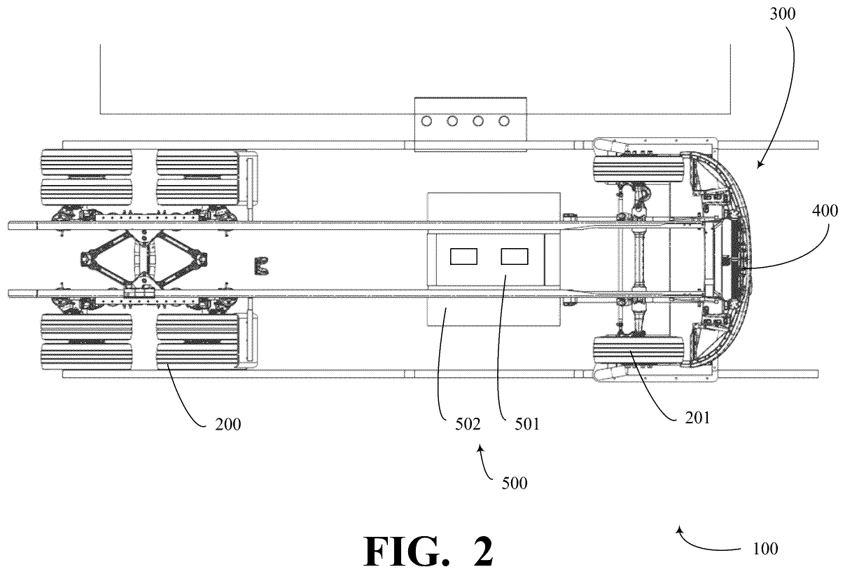

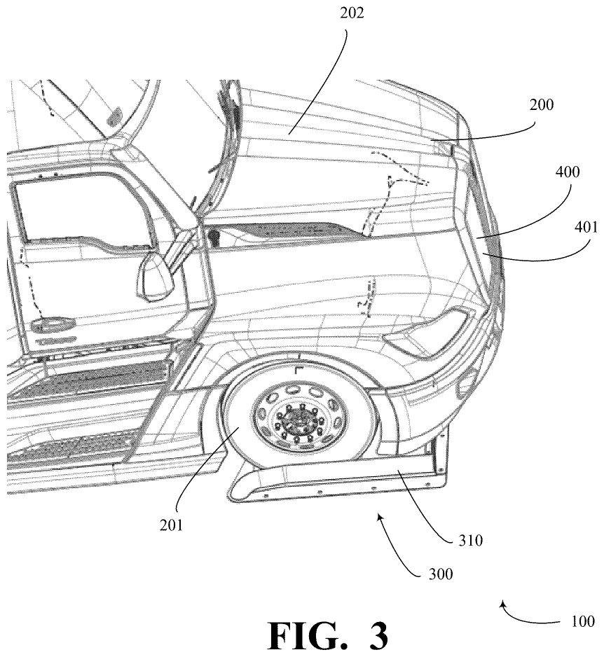

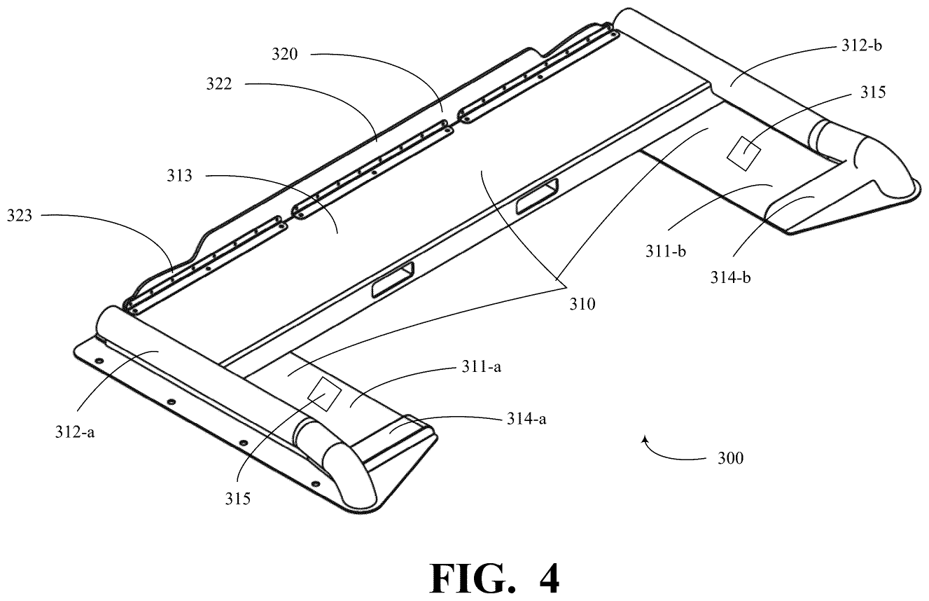

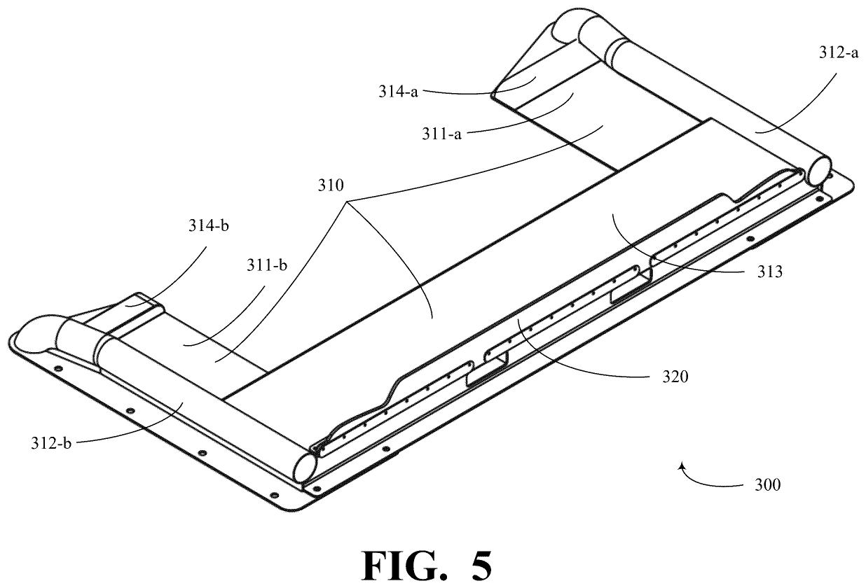

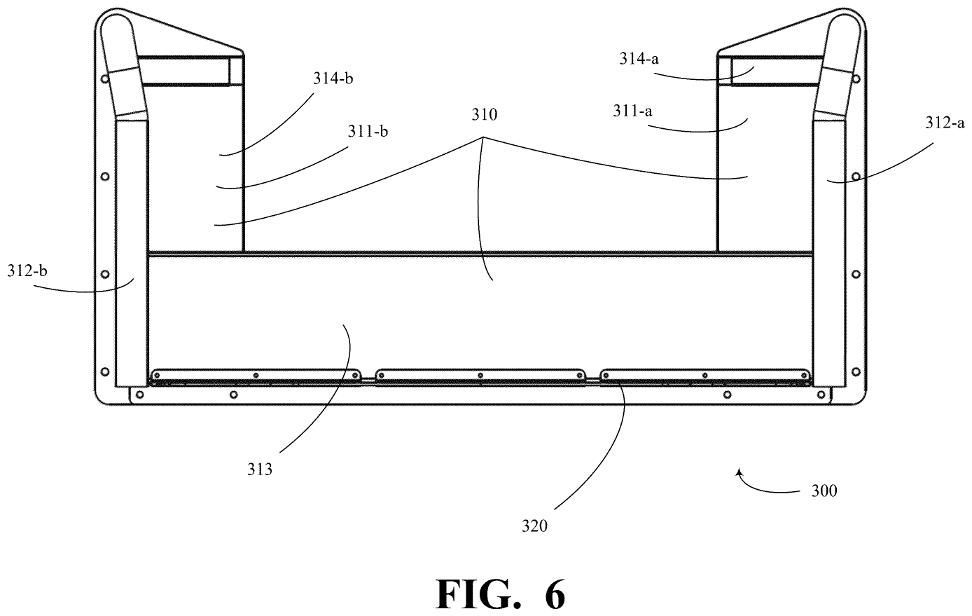

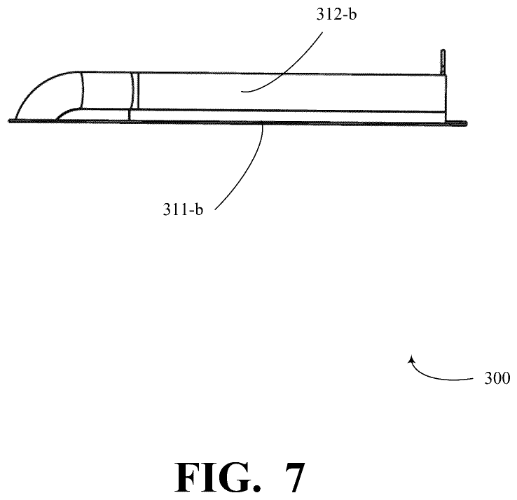

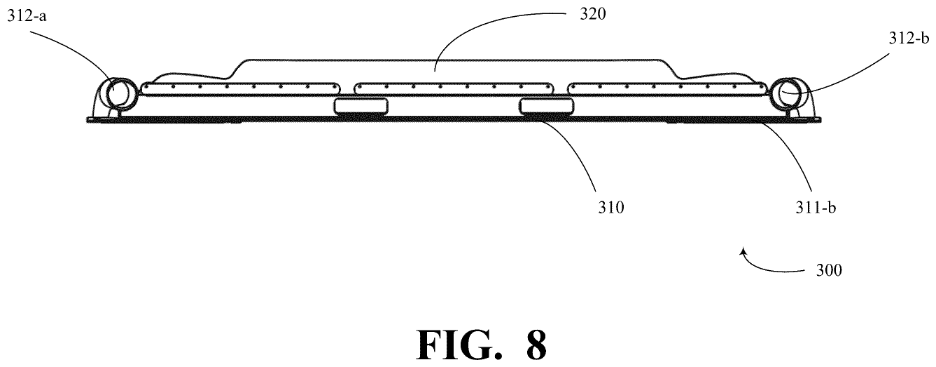

FIGS. 1-3 illustrate vehicle system 100. FIGS. 4-8 illustrate docking station system 300. Referring concurrently to FIGS. 1-8, vehicle system 100 includes vehicle 200, docking station system 300, cooling system 400, and wireless charging system 500. Vehicle 200 includes tires 201 and front portion 202. Docking station system 300 includes docking station 310 and air shield 320. Docking station 310 includes base pads 311, side alignment bars 312, front alignment portion 313, and back bars 314. In some examples, docking station 310 includes pressure sensor 315. Wireless charging system 500 includes first wireless charging device 501, second wireless charging device 502, and one or more batteries 503.

In some examples, docking station 310 and air shield 320 may form a single integral part. For example, docking station 310 and air shield 320 may be formed in a casting, forging, or molding process, although other manufacturing processes are possible and contemplated. In other examples, docking station 310 and air shield 320 may be separately formed and coupled to one another via any suitable process, such as welding, adhesive-based coupling, mechanical coupling, or the like. In yet other examples, docking station 310 and air shield 320 may be completely separate parts that are not connected or coupled to one another.

In some examples, base pads 311, side alignment bars 312, front alignment portion 313, and back bars 314 may form a single integral part. For example, base pads 311, side alignment bars 312, front alignment portion 313, and back bars 314 may be formed in a casting, forging, or molding process, although other manufacturing processes are possible and contemplated. In other examples, base pads 311, side alignment bars 312, front alignment portion 313, and back bars 314 may be separately formed and coupled to one another via any suitable process, such as welding, adhesive-based coupling, mechanical coupling, or the like.

In examples, vehicle 200 is a transport vehicle designed to haul cargo. For example, vehicle 200 may be a semi-truck. In other examples, other vehicles 200 may comprise a passenger car, motorcycle, all-terrain vehicles, light-duty or medium-duty truck, etc. Vehicle 200 may be an electric vehicle (EV) or a hybrid vehicle. Vehicle 200 may be configured to be wirelessly charged using, for example, one or more charge plates and one or more batteries to store electrical energy. Vehicle 200 may be able to be wirelessly charged without operator involvement. For example, vehicle 200 may be able to be oriented or positioned substantially adjacent to (e.g., over) a wireless charge plate to begin charging vehicle 200. In some examples, some or all of cooling system 400 and/or wireless charging system 500 and/or air shield 320 may be attached to or be a part of or included in vehicle 200. Wireless charging system 500 may be configured to support wireless charging at significant rates (e.g., approximately 1 MW, 10 MW, or any other value). Vehicle 200 may also include tires 201 (which, as used herein, can include solid wheels) and front portion 202, such as a front bumper.

Front portion 202 is a portion of the vehicle located substantially in the front of vehicle 200. For example, front portion 202 may include portions of vehicle 200 that are in the front half of vehicle 200. In some other examples, front portion 202 may comprise a portion of a tractor vehicle 200. In some other examples, front portion 202 may include any portion of vehicle 200 that is in front of the two rearmost points of tires 201 (e.g., the front tires of vehicle 200). In some other examples, front portion 202 may include any portion of vehicle 200 that is in front of first wireless charging device 501. In some other examples, front portion 202 may comprise or may include a bumper.

Docking station 310 may be configured to receive tires 201 to align vehicle 200. For example, when vehicle 200 is docked in docking station 310, first wireless charging device 501 may be aligned with second wireless charging device 502 so that vehicle 200 (e.g., batteries 503) may be wirelessly charged. Additionally, when vehicle 200 is docked in docking station 310, air shield 320 may be deployed or otherwise in position to restrict airflow from under the vehicle 200 (where air heated by wireless charging system 500 is exhausted) to the cool air intake 401 of cooling system 400. Docking station 310 may be configured to be mounted to otherwise fixed to the ground or any other surface.

In some examples, docking station 310 includes base pads 311, side alignment bars 312, front alignment portion 313, and back bars 314. In the depicted examples, base pads 311 are substantially flat sheets that form the base of docking station 310 and include a top surface onto which vehicle 200 may drive (e.g., tires 201 may contact the top surface of base pads 311 when vehicle 200 is docked). Base pads 311 may be coupled with side alignment bars 312, front alignment portion 313, and back bars 314. For example, base pad 311-a may be coupled with side alignment bar 312-a, front alignment portion 313, and back bar 314-a. Base pad 311-b may be coupled with side alignment bar 312-b, front alignment portion 313, and back bar 314-b. Base pads 311 may be substantially rectangular though other shapes a possible and contemplated. In some examples, base pads 311 may include one or more through holes to facilitate being secured into the ground or any other surface. Base pads 311 may be made of substantially any material including plastics, metals, ceramics, or a combination of these.

In the depicted examples, side alignment bars 312 are raised elongated cylinders or tubes disposed near the outside edges of base pads 311. Side alignment bars 312 are configured to align tires 201 in docking station 310. In some examples, side alignment bars are hollow. In some other examples, side alignment bars are solid. In some examples, one or both ends of side alignment bars may be coupled with base pads 311. For example, rear portions of side alignment bars 312 may turn downwards to couple with and contact base pads 311. In some examples, side alignments bars 312 may include one or more columns placed along the length of side alignment bars 312 coupling side alignment bars 312 with base pads 311 to provide support for side alignment bars 312. Side alignment bars 312 may be made of substantially any material including plastics, metals, ceramics, or a combination of these.

In examples, front alignment portion 313 is an elongated portion of material that couples and bridges base pad 311-a and/or side alignment bar 312-a with base pad 311-b and/or side alignment bar 312-b. For example, front alignment portion 313 is disposed between base pad 311-a and/or side alignment bar 312-a and base pad 311-b and/or side alignment bar 312-b. Front alignment portion 313 may be made of substantially any material including plastics, metals, ceramics, or a combination of these. Front alignment portion 312 is disposed substantially at the front of docking station 312 and at the front of base pads 311 such that tires 201 are disposed behind front alignment portion 313. In this way, front alignment portion 313 acts as a stop for tires 201 to align tires 201 between front alignment portion 313 and back bars 314. A height of front alignment portion 313 may be higher than that of back bars 314 and side alignment bars 312. In some other examples, heights of side alignment bars 312 may be higher than the height of front alignment portion 313.

In examples, back bars 314 are raised bars of material that extend from base pads 311 and act as a “bump” that tires 201 may roll over and secure tires 201 in docking station 310 to maintain alignment. As such, tires 201 are disposed substantially in front of back bars 314 when vehicle 200 is docked at docking station 310. Back bars 314 may extend from side alignment bars 312 and substantially to the inside edges of base pads 311. Back bars 314 may be rectangular prisms, semi-cylinders, or the like. In some examples, heights of back bars 314 may be lower than heights of side alignment bars 312 and/or front alignment portion 313. Back bars 314 may be made of substantially any material including plastics, metals, ceramics, or a combination of these.

Other designs of docking station 310 are possible and contemplated. For example, rather than side alignment bars 312, substantially any design of raised material near the outside edges of base pads 311 may be used.

In examples, pressure sensors 315 are components designed to produce an output in response to a sensed pressure. For example, pressure sensors 315 may be coupled to docking station 310 and may detect force(s) exerted by tires 201 when tires 201 are docked in docking station 310. For example, pressure sensors 315 may be coupled to docking station 310 and disposed under tires 201 when vehicle 200 is docked. Responsive to detecting the force(s) exerted by tires 201 on pressure sensors 315, one or both of pressure sensors 315 may provide a signal to air shield control 900 (discussed hereinafter). For example, when the air shield control 900 receives the signal(s) from pressure sensors 315, the air shield control 900 may generate a signal to cause air shield 320 to deploy (e.g., deploy air shield 320 upwards when air shield 320 is coupled to docking station 310, or deploy air shield 320 downwards when air shield 320 is coupled to vehicle 200). In some other examples, pressure sensor(s) 315 may induce a mechanical response to deploy air shield 320 responsive to detecting the force(s) exerted by tires 201 on pressure sensors 315. For example, one or more mechanical power transmission components may facilitate the transfer of force exerted by tires 201 on pressure sensors 315 to a deployment mechanism 901 for air shield 320. Such mechanical power transmission components may include linear transmission components (e.g., levers), circular transmission components (e.g., gears), and/or circular movement-to-linear components (e.g., rack and pinion), among others. Other types of sensors 315 are also possible and contemplated, such as time-of-flight sensors that can be used to sense if the area above a portion of docking station 310 is currently occupied.

An ambient or cool air intake 401 of the cooling system 400 is designed to receive ambient air from the environment and use the ambient air to cool wireless charging system 500, or at least the first wireless charging device 501 that is located in the vehicle. Cooling system 400 may be located on and coupled to vehicle 200. For example, cooling system 400 may be coupled to front portion 202 of vehicle 200. For example, cooling system 400 may include a cool air intake 401, including a passageway that begins at a front grille (grated opening) in a front portion of vehicle 200. Cooling system 400 is designed to take in ambient air when vehicle 200 is at rest. As such, cooling system 400 may include a cool air intake 401 comprising an opening in the exterior of the vehicle 200 (such as one or more grate-covered opening in the front of the vehicle 200) and a passageway (which may include tubing and a filter). Cooling system 400 may also include an air pump, a fan, or a combination of these to move air from outside vehicle 200, through the passageway, and into an interior cavity of vehicle 200 to cool wireless charging device 501 and/or other liquid cooled components on the truck. For example, the cooler air from outside of the cavity that houses the batteries of wireless charging device 501 may be drawn in by a fan, which may be powered by the batteries. The air may then be forced over and around the batteries such that the air, after having been heated by the cooling system 400 or batteries, is exhausted out of the vehicle, such as to an underside of the vehicle. As discussed, the heated air is then restricted from being drawn back into the cool air intake 401 of cooling system 400 by the air shield 320.

Wireless charging system 500 may comprise substantially any electrical system designed to wirelessly charge one or more batteries. Wireless charging system 500 may include first wireless charging device 501, second wireless charging device 502, and one or more batteries 503 (e.g., which may be included in first wireless charging device 501, or may be separate from first wireless charging device 501 but included on/in vehicle 200). First wireless charging device 501 may be part of vehicle 200, while second wireless charging device 502 may be located on the ground or on any surface below vehicle 200 when vehicle 200 is docked in docking station 310. In examples, first wireless charging device 501 may comprise one or more receiver coils, that receive an electromagnetic field from the second wireless charging device, a power management conversion system that converts the direct current power from the receiver coil(s) into a desired voltage and current, and one or more batteries or battery packs configured to store the received energy. The first wireless charging device 501 may also include a receiver charging control unit to control the power management conversion system and other vehicle systems to allow efficient and safe charging. In examples, the electrical signal causing the air shield 320 to be deployed or stowed may be provided by such receiver charging control unit based on the initiation or termination of charging. Second wireless charging device 502 may be configured to provide electrical energy wirelessly to first wireless charging device 501 to charge vehicle 200 when vehicle 200 is docked in docking station 310. The second wireless charging device 502 may comprise one or more transmitter coil(s), a power conversion system to convert alternating-current power from a power source to direct-current power, a transmitter charging control unit to manage the charging process from the transmitter side, and a control unit. In examples, the electrical signal causing the air shield 320 to be deployed or retracted may be provided by such transmitter charging control unit based on the initiation or termination of charging. In examples, the docking station 310 is positioned such that, when the vehicle 200 is received in the docking station 310, the receiver coil(s) of the first wireless charging device 501 is/are positioned substantially over the transmitter coil(s) of the second wireless charging device 502.

Air shield 320 may comprise a component disposed in between vehicle 200 and the ground to restrict airflow from under the vehicle 200 to the cool air intake 401 of cooling system 400. The air shield 320 is depicted as restricting airflow from under vehicle 200 to the front portion of vehicle 200 because the cool or ambient air intake 401 to the cooling system 400 is located in the front portion of vehicle 200 in this example. Those of skill in the art will appreciate, however, that the air shield 320 could also be disposed on or along one or more sides or the rear of the vehicle 200 to accommodate a different location of the cooling system (e.g., if the ambient air is pulled in through an opening on the side or rear of vehicle 200). Air shield 320 may be made of substantially any material including rubber, plastic, metal, ceramic, or a combination of these. In some examples, air shield 320 may be a substantially flat and/or rectangular sheet of material. In some examples, air shield 320 may be rigid. Air shield 320 may be oriented vertically or angled (e.g., up to 45 degrees from vertical) to restrict airflow from under the vehicle 200 (as heated by wireless charging system 500) and the intake point of cooling system 400. In some other examples, at least a portion of air shield 320 (e.g., a distal end) may deform to fit a space between the ground and front portion 202. For example, air shield 320 may deform forward and/or down when vehicle 200 contacts air shield 320 when vehicle 200 is docked in docking station 310. In some examples, air shield 320 may include multiple flexible fingers (e.g., grass-style), or bristles that extend upwards to contact front portion 202 that deform and/or adapt and/or flexibly mold to fit the shape of the space between the ground and front portion 202 (e.g., deform and/or adapt and/or flexibly mold to fit the shape of the bumper of vehicle 200). In some examples, a surface area of surface 321 of air shield 320 may be greater than a surface area of a vertical plane constrained by the space between the ground and front portion 202 (e.g., the space under vehicle 200). As such, air shield 320 may be able to accommodate different vehicles having different sized spaces between the ground and front portion 202.

In some examples, air shield 320 is coupled to docking station 310. For example, air shield 320 may be coupled to docking station 310 near the front of docking station 310. For example, air shield 320 may be coupled to front alignment portion 313. In some other examples, air shield 320 may be coupled to any part of docking station 310, such as base pads 311, side alignment bars 312, front alignment portion 313, or a combination of these. Air shield 320 (when deployed) may be oriented vertically or at any angle, as described previously. In some examples, when the vehicle 200 is docked, there may be a gap between a distal end of air shield 320 and front portion 202 (e.g., an underside of vehicle 200, a bumper) of vehicle 200. For example, the gap may be less than 1 inch (e.g., 10 millimeters), 2 inches, 3 inches, or any other value. The gap may be less than 50% of the vertical height of air shield 320 when air shield 320 is deployed or configured on docking station 310, less than 25% of the vertical height, or any other value. In some examples, air shield 320 may have a shape so as to substantially fit the underside of vehicle 200 (e.g., the underside of front portion 202) while leaving a same gap (or substantially no gap) in between different points of air shield 320 and corresponding points of the underside of front portion 202. For example, portion 322 of air shield 320 may be higher than portion 323 of air shield 320 so as to leave a consistent gap distance between portion 322 and front portion 202 and between portion 323 and front portion 202. In some other examples, there may be substantially no gap between the distal end of air shield 320 and front portion 202 of vehicle 200. For example, when air shield 320 deforms to fit between docking station 310 and front portion 202, there may be substantially no gap between the distal end of air shield 320 and front portion 202 of vehicle 200.

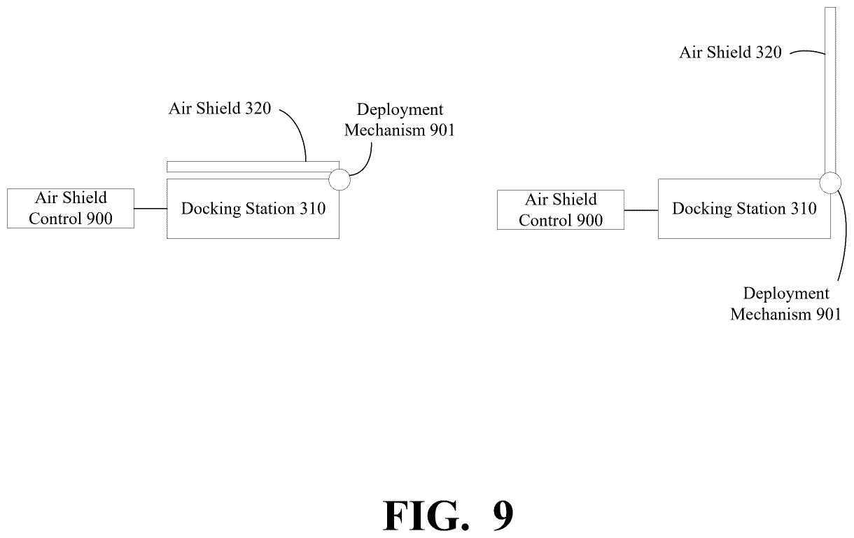

In some examples, the air shield 320 may be stowable on docking station 310 and deployable from docking station 310, as conceptually illustrated in FIG. 9. For example, in a stowed position, the air shield 320 may extend in a plane substantially parallel to the ground. In a deployed position, the air shield 320 may extend in a plane substantially orthogonal to the ground or at another angle sufficient to substantially restrict air heated by the charging system 500 from being pulled from under vehicle 200 into the cool air intake 401 of cooling system 400. Various mechanisms may be used to deploy the air shield 320 from a stowed position to a deployed position, and vice versa, via a deployment mechanism 901. Moving the air shield 320 from a stowed position to a deployed position (or vice versa) may occur automatically when the vehicle is determined to be in position for wireless charging of the vehicle or when the docking station 310 receives the vehicle 200 (e.g., tires 201). For example, moving the air shield 320 from a stowed position to a deployed position (or vice versa) may occur automatically in response to a signal (e.g., a wireless signal, a wired signal). Air shield control 900 may provide the signal. For example, air shield control 900 may include an electronic or computing device configured to provide a signal (wired or wireless) to docking station 310 or vehicle 200 to move air shield 320 via deployment mechanism 901. Air shield control 900 may be included on a user device, on docking station 310, on vehicle 200, or any other component described herein. The signal may be generated when the vehicle 200 or the docking station 310 (or a related system) senses that the vehicle 200 is in position for charging, which may include sensing that the vehicle 200 has begun charging using wireless charging system 500 or that wireless charging devices 501 and 502 are aligned. In examples, receiving tires 201 in docking station 310 may cause deployment mechanism 901 to be activated based on, e.g., receiving a signal at air shield control 900 from one or more sensors, such as pressure sensors on the docking station 310. Air shield 320 may also be deployed in response to a signal generated in response to an operator actuating a user interface element (e.g., air shield control 900, may include a computer-displayed user interface element, a physical button or switch on the vehicle 200 or the docking station 310, or otherwise).

In other examples, the air shield 320 may be manually deployed and stowed without requiring an air shield control 900, e.g., one or more hinged components may be provided as part of deployment mechanism 901 that permit the air shield 320 to be manually rotated along a fixed axis (either on the vehicle 200 or on the docking station 310, for example) and lock into (by friction or otherwise) a particular position (e.g., allowing rotation of the air shield 320 through at least ninety degrees). In some other examples, air shield 320 may be mechanically moved from a stowed to a deployed position when tires 201 are received in docking station 310. For example, the deployment mechanism 901 may comprise mechanical linkages that are actuated in response to the weight of the vehicle 200 being received onto the docking station 310 and mechanically causing the air shield 320 to flip up from a stowed position to a deployed position. In some examples, the air shield 320 may be caused to deploy by deployment mechanism 901 comprising a mechanical linkage between the base pads 311 and the air shield 320.

In some examples, air shield control 900 may be configured to generate a signal to cause air shield 320 to deploy (e.g., rise vertically) from docking station 310 responsive to one or more conditions being satisfied. For example, air shield 320 may be configured to deploy when tires 201 are received by docking station 310 (e.g., when tires 201 exert forces on pressure sensors 315), when vehicle 200 senses second wireless charging device 502 is located substantially underneath first wireless charging device 501, when vehicle 200 is in a wireless charging mode, or a combination of these.

As discussed, air shield 320 may be configured to deploy from docking station 310 (e.g., from front alignment portion 313) using one or more deployment mechanism 901 as conceptually illustrated in, for example, FIG. 9. For example, deployment mechanism 901 may include one or more loaded springs, which may be released to raise air shield 320 upwards when a condition described previously is satisfied. In some other examples, the deployment mechanism 901 comprises one or more actuators (e.g., electric, hydraulic, and/or pneumatic) included in docking station 310, which may be actuated to raise air shield 320 when one or more of the discussed conditions is satisfied. For example, deployment mechanism 901 may comprise a motor configured to rotate the air shield 320 along a fixed axis such that a distal edge of the air shield 320 is moved to contact (or nearly contact) a portion (e.g., a front portion) the vehicle 200. Other mechanisms for deployment mechanism 901 may be contemplated, including linkage mechanisms, screw jacks, lever systems, pulleys, cables, cam and follower mechanisms, rack and pinion mechanisms, scissor lift mechanisms, and/or hydraulic lift mechanisms.

Alternatively, air shield 320 may be a substantially static component that remains in a fixed configuration (e.g., fixedly coupled to the docking station 310) designed to restrict airflow. For example, it may remain oriented substantially vertically or at any sufficient angle. In examples, the air shield 320 remains coupled to docking station 310 and remains in a configuration where the distal end of air shield 320 is at a height that is greater than a height of base pads 311, side alignment bars 312, front alignment portion 313, back bars 314, or a combination of these. In examples, the height of the air shield 320 may be sufficient to contact the front portion 202 of the vehicle 200 when the tires of vehicle 200 are received in docking station 310.

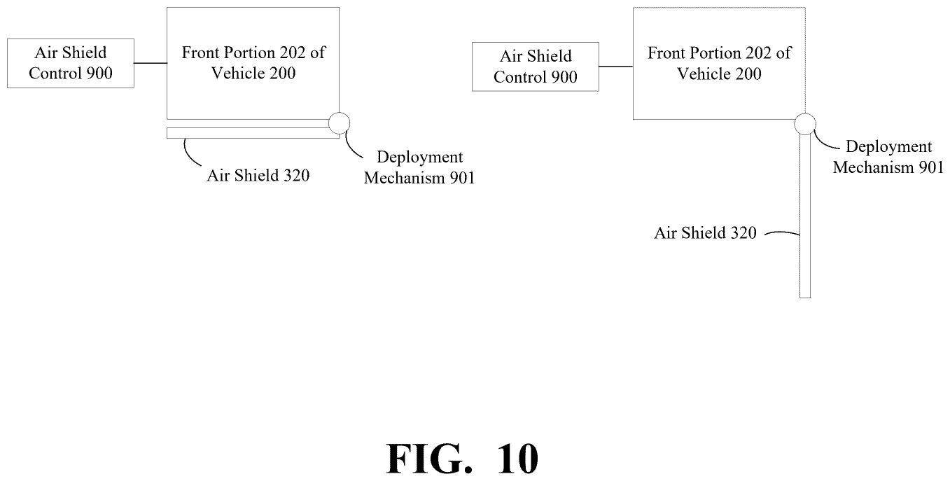

In FIGS. 1-9, the air shield 320 is depicted as attached to docking station 310. In some other examples, air shield 320 may be coupled to vehicle 200 (e.g., to front portion 202, such as a bumper), as conceptually illustrated in, for example, FIG. 10. Air shield 320 (when deployed) may be oriented vertically or at another sufficient angle to restrict air flow from under the vehicle 200 to an ambient or cool air intake 401 of the cooling system 400, as described previously. In examples, if the air shield 320 is coupled to vehicle 200, then it may not be necessary to have a docking station 310. In some examples, a distal end of air shield 320 may be configured to contact a ground surface or a portion of docking station 310, when deployed. In some examples, when the vehicle 200 is docked or wirelessly charging, there may be a gap between a distal end of air shield 320 and docking station 310 or another surface underneath vehicle 200 (e.g., the ground). For example, the gap may be less than 1 inch (e.g., 10 millimeters), 2 inches, 3 inches, or any other value. The gap may be less than 50% of the vertical height of air shield 320 when air shield 320 is deployed or configured on docking station 310, less than 25% of the vertical height, or any other value. In some other examples, there may be substantially no gap between the distal end of air shield 320 and docking station 310 or any other surface underneath vehicle 200. In some examples, air shield 320 may have a shape and configuration so as to substantially conform the ground surface or docking station 310 while leaving a same gap (or substantially no gap) in between different points of air shield 320 and corresponding points of the ground surface or docking station 310. In some examples, air shield 320 may be configured to deploy from vehicle 200 responsive to one or more condition being satisfied, such as the conditions discussed with respect to FIG. 9. For example, air shield 320 may be configured to deploy when tires 201 are received by docking station 310 (e.g., when tires 201 exert forces on pressure sensors 315), when vehicle 200 senses second wireless charging device 502 is located substantially underneath first wireless charging device 501, when vehicle 200 is in a wireless charging mode, or a combination of these.

In examples where air shield 320 is attached to vehicle 200, and as shown conceptually in FIG. 10, the air shield 320 may extend in a plane substantially parallel to the ground when in a stowed position. In examples, this is advantageous to prevent unwanted effect on the aerodynamic performance of vehicle 200 when the vehicle 200 is moving. In a deployed position, the air shield 320 may extend in a plane substantially orthogonal to the ground or at another angle sufficient to substantially restrict air heated by the charging system 500 from being pulled from under vehicle 200 into the cool air intake 401 of cooling system 400. Various deployment mechanisms 901 may be used to deploy the air shield 320 from a stowed position to a deployed position, and vice versa, such as one or more of the deployment mechanisms 901 described with respect to FIG. 9 (with the air shield 320 deploying down, instead of up). Moving the air shield 320 from a stowed position to a deployed position (or vice versa) may occur when the vehicle 200 is in position for wireless charging of the vehicle and/or when the docking station 310 receives the vehicle 200 (e.g., tires 201). For example, moving the air shield 320 from a stowed position to a deployed position (or vice versa) may occur automatically in response to a signal produced by air shield control 900, as previously described. As discussed, air shield control 900 may be included on a user device, on docking station 310, on vehicle 200, or somewhere else. The signal may be generated (e.g., by the vehicle 200) when the vehicle 200 or the docking station 310 (or a related system) senses that the vehicle 200 is in position for charging and/or when the vehicle 200 begins charging using wireless charging system 500. Air shield 320 may also be manually deployed, as previously described with respect to FIG. 9.

In examples, at least a portion of air shield 320 (e.g., a distal end) may deform to fit a space between the ground and front portion 202. For example, air shield 320 may be deformed backwards and/or up by the ground or by docking station 310 when air shield 320 is deployed from vehicle 200. In some examples, air shield 320 may include multiple flexible fingers (e.g., grass-style), or bristles that extend downwards to contact the ground or docking station 310 and that deform and/or adapt and/or flexibly mold to fit the shape of the space between the ground/docking station 310 and front portion 202. In some examples, a surface area of surface 321 of air shield 320 may be greater than a surface area of a vertical plane constrained by the space between the ground and front portion 202 (e.g., the space under vehicle 200). As such, air shield 320 may be able to accommodate different docking stations having different sized spaces between the docking station 310 and front portion 202.

As discussed, air shield 320 may be configured to deploy (e.g., lower vertically) from vehicle 200 (e.g., from front portion 202, which may be or may include a bumper) using a same or similar deployment mechanism 901 as previously described with respect to FIG. 9. In some other examples, a trap door deployment mechanism 901 on vehicle 200 may be configured to open when one or more of the described conditions is met, and air shield 320 may slide down a channel when the trap door mechanism is opened. In some examples, air shield 320 may be deployed (e.g., raised, pushed, or otherwise moved) downwards from vehicle 200 using such deployment mechanisms 901 by vehicle 200. In some other examples, air shield 320 may be deployed manually such as by rotating it down (and similarly stowed by rotating air shield 320 back up so as to preserve clearance and aerodynamic performance when the vehicle 200 is in use). Alternatively, air shield 320 may be a substantially static component that remains in a fixed configuration (e.g., fixedly coupled to the vehicle 200) designed to restrict airflow (e.g., remains oriented vertically or at another angle).

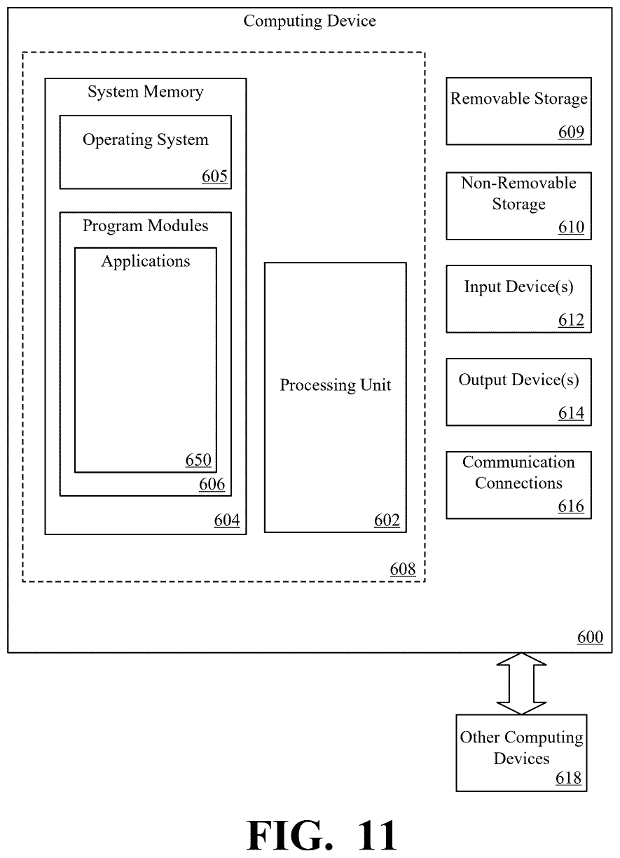

FIG. 11 is a block diagram illustrating physical components (i.e., hardware) of a computing device 600 with which examples of the present disclosure may be practiced. The computing device 600 or components thereof may be included in air shield control 900 (FIGS. 9, 10). One or more operations performed by air shield control 900 may be performed or executed by computing device 600. In a basic configuration, the computing device 600 may include at least one processing unit 602 and a system memory 604. The processing unit(s) (e.g., processors) may be referred to as a processing system. Depending on the configuration and type of computing device, the system memory 604 may comprise, but is not limited to, volatile storage (e.g., random access memory), non-volatile storage (e.g., read-only memory), flash memory, or any combination of such memories. The system memory 604 may include an operating system 605 and one or more program modules 606 suitable for running software applications 650 to implement one or more of the systems described above with respect to FIGS. 9 and 10.

The operating system 605, for example, may be suitable for controlling the operation of the computing device 600. Furthermore, aspects of the invention may be practiced in conjunction with a graphics library, other operating systems, or any other application program and is not limited to any particular application or system. This basic configuration is illustrated in FIG. 11 by those components within a dashed line 608. The computing device 600 may have additional features or functionality. For example, the computing device 600 may also include additional data storage devices (removable and/or non-removable) such as, for example, magnetic disks, optical disks, or tape. Such additional storage is illustrated in FIG. 11 by a removable storage device 609 and a non-removable storage device 610.

As stated above, a number of program modules and data files may be stored in the system memory 604. While executing on the processing unit 602, the program modules 606 may perform processes including, but not limited to, one or more of the operations described herein (e.g., as performed by air shield control 900). Other program modules that may be used in accordance with examples of the present invention and may include applications such as electronic mail and contacts applications, word processing applications, spreadsheet applications, database applications, slide presentation applications, drawing or computer-aided application programs, etc.

Furthermore, examples of the invention may be practiced in an electrical circuit comprising discrete electronic elements, packaged or integrated electronic chips containing logic gates, a circuit utilizing a microprocessor, or on a single chip containing electronic elements or microprocessors. For example, examples of the invention may be practiced via a system-on-a-chip (SOC) where each or many of the components illustrated in FIG. 11 may be integrated onto a single integrated circuit. Such an SOC device may include one or more processing units, graphics units, communications units, system virtualization units and various application functionality all of which are integrated (or “burned”) onto the chip substrate as a single integrated circuit. When operating via an SOC, the functionality, described herein, with respect to generating suggested queries, may be operated via application-specific logic integrated with other components of the computing device 600 on the single integrated circuit (chip). Examples of the present disclosure may also be practiced using other technologies capable of performing logical operations such as, for example, AND, OR, and NOT, including but not limited to mechanical, optical, fluidic, and quantum technologies.

The computing device 600 may also have one or more input device(s) 612 such as a keyboard, a mouse, a pen, a sound input device, a touch input device, etc. The output device(s) 614 such as a display, speakers, a printer, etc. may also be included. The aforementioned devices are examples and others may be used. The computing device 600 may include one or more communication connections 616 allowing communications with other computing devices 618. Examples of suitable communication connections 616 include, but are not limited to, RF transmitter, receiver, and/or transceiver circuitry; universal serial bus (USB), parallel, and/or serial ports.

The term computer readable media as used herein may include computer storage media. Computer storage media may include volatile and nonvolatile, removable and non-removable media implemented in any method or technology for storage of information, such as computer readable instructions, data structures, or program modules. The system memory 604, the removable storage device 609, and the non-removable storage device 610 are all computer storage media examples (i.e., memory storage.) Computer storage media may include RAM, ROM, electrically erasable programmable read-only memory (EEPROM), flash memory or other memory technology, CD-ROM, digital versatile disks (DVD) or other optical storage, magnetic cassettes, magnetic tape, magnetic disk storage or other magnetic storage devices, or any other article of manufacture which can be used to store information and which can be accessed by the computing device 600. Any such computer storage media may be part of the computing device 600. Computer storage media may be non-transitory and tangible and does not include a carrier wave or other propagated data signal.

Communication media may be embodied by computer readable instructions, data structures, program modules, or other data in a modulated data signal, such as a carrier wave or other transport mechanism, and includes any information delivery media. The term “modulated data signal” may describe a signal that has one or more characteristics set or changed in such a manner as to encode information in the signal. By way of example, and not limitation, communication media may include wired media such as a wired network or direct-wired connection, and wireless media such as acoustic, RF, infrared, and other wireless media.

Those skilled in the art will recognize that the methods and systems of the present disclosure may be implemented in many manners and as such are not to be limited by the foregoing aspects and examples. In this regard, any number of the features of the different aspects described herein may be combined into single or multiple aspects, and alternate aspects having fewer than or more than all of the features herein described are possible. Functionality may also be, in whole or in part, distributed among multiple components, in manners now known or to become known.

Moreover, the scope of the present disclosure covers conventionally known manners for carrying out the described features and functions, and those variations and modifications that may be made to the components described herein as would be understood by those skilled in the art now and hereafter. In addition, some aspects of the present disclosure are described above with reference to block diagrams and/or operational illustrations of systems and methods according to aspects of this disclosure. The functions, operations, and/or acts noted in the blocks may occur out of the order that is shown in any respective flowchart. For example, two blocks shown in succession may in fact be executed or performed substantially concurrently or in reverse order, depending on the functionality and implementation involved.

Further, as used herein and in the claims, the phrase “at least one of element A, element B, or element C” is intended to convey any of: element A, element B, element C, elements A and B, elements A and C, elements B and C, and elements A, B, and C. In addition, one having skill in the art will understand the degree to which terms such as “about” or “substantially” convey in light of the measurements techniques utilized herein. To the extent such terms may not be clearly defined or understood by one having skill in the art, the term “about” shall mean plus or minus ten percent, and when used with respect to angular measurements, the term “substantially” shall mean within plus or minus ten degrees (e.g., “substantially perpendicular” shall mean within ten degrees from exactly perpendicular, and “substantially parallel” shall mean within ten degrees from exactly parallel).

Numerous other changes may be made which will readily suggest themselves to those skilled in the art and which are encompassed in the spirit of the disclosure and as defined in the appended claims. While various aspects have been described for purposes of this disclosure, various changes and modifications may be made which are well within the scope of the disclosure. Numerous other changes may be made which will readily suggest themselves to those skilled in the art and which are encompassed in the spirit of the disclosure and as defined in the claims.

What is claimed is:

1. A docking station system for a vehicle, comprising:
a docking station configured to receive a set of tires of the vehicle to align the vehicle; and
an air shield coupled to a front alignment portion of the docking station and configured to extend upwards from the docking station and, when a vehicle is docked at the docking station, to restrict air flow from beneath the vehicle to a cooling system.

2. The docking station system of claim 1, wherein the docking station comprises base pads that receive the set of tires, side alignment bars that align the set of tires, a front alignment portion disposed between portions of the base pads and the side alignment bar, and back bars that extend from the base pads.

3. The docking station system of claim 1, wherein the air shield is fixedly coupled to the docking station.

4. The docking station system of claim 1, wherein a distal end of the air shield is configured to be deformable.

5. The docking station system of claim 1, wherein the air shield is configured to extend substantially vertically when in a deployed position and extend substantially horizontally when in a stowed position.

6. The docking station system of claim 5, wherein the air shield is configured to move from the stowed position to the deployed position when base pads of the docking station receive the set of tires of the vehicle.

7. The docking station system of claim 1, wherein at least a portion of the air shield is configured to flexibly mold to a front portion of the vehicle upon contact with the front portion of the vehicle.

8. The docking station system of claim 7, wherein the air shield comprises a plurality of flexible fingers or bristles.

9. The docking station system of claim 1, wherein the air shield is configured to move from a stowed position to a deployed position, and wherein the air shield moving from the stowed position to the deployed position occurs in response to a signal.

10. The docking station system of claim 1, wherein the front alignment portion aligns the vehicle such that a first wireless electric charging device of the vehicle is disposed over a second wireless electric charging device below the vehicle.

11. The docking station system of claim 1, wherein the air shield is configured to move from a stowed position to a deployed position based at least in part on a force exerted by the set of tires of the vehicle on at least one pressure sensor disposed on the docking station.

12. A docking station system, comprising:
a docking station configured to receive at least one tire of a vehicle to align the vehicle, wherein the docking station is configured to provide a signal to cause an air shield to move from a stowed position to a deployed position to restrict air flow from beneath the vehicle to a cooling system.

13. The docking station system of claim 12, further comprising the air shield.

14. The docking station system of claim 12, wherein the air shield is coupled to the docking station.

15. The docking station system of claim 12, wherein the docking station further comprises a pressure sensor, and wherein the signal is provided based at least in part on a signal from the pressure sensor indicating that the vehicle is docked at the docking station.

16. A system, comprising:
an air shield configured to restrict flow of air from under a vehicle;
at least one processor; and
memory, operatively connected to the at least one processor and storing executable instructions that, when executed, cause the at least one processor to perform operations, the operations comprising:
detecting that the vehicle is in position for wireless charging of the vehicle; and
providing at least one signal to move the air shield from a stowed position to a deployed position based at least in part on detecting that the vehicle is in position for wireless charging of the vehicle.

17. The system of claim 16, wherein detecting that the vehicle is in position for wireless charging comprises determining that the docking station receives a set of tires of the vehicle to align the vehicle.

18. The system of claim 16, wherein the air shield is coupled to the docking station and wherein the processor or memory comprise a portion of the vehicle or of the docking station.

19. The system of claim 16, wherein detecting that the vehicle is in position for wireless charging comprises determining that the vehicle is in a wireless charging mode.

20. The system of claim 16, wherein the air shield is coupled to the vehicle and wherein the processor or memory comprise a portion of the vehicle or of the docking station.
